(19) United States
(12) Patent Application Publication
(10) Pub. No.: US 2012/0060832 A1
(43) Pub. Date: Mar. 15, 2012

(54) PROCESS FOR PRODUCING GRANULATED REFINED SUGAR FROM SUGAR CANE JUICE

(75) Inventor: Fernando Cesar BOSCARIOL, Sao Paulo (BR)

(73) Assignee: DEDINI SIA INDUSTRIAS DE BASE, Sao Paulo (BR)

(21) Appl. No.: 13/301,868

(22) Filed: Nov. 22, 2011

Related U.S. Application Data
(63) Continuation-in-part of application No. 11/719,758, filed on May 21, 2007, now abandoned.

(30) Foreign Application Priority Data
Nov. 24, 2004 (BR) PI0405323-0

(51) Int. Cl. C13B 35/06

(52) U.S. Cl. 127/46.2

(57) ABSTRACT

The process includes phases of: (I) treatment, initial clarification and concentration (TC) of sugar cane juice, with 13-18° Brix, through treatment, decantation and concentration of the juice, for a syrup concentration of 60-65° Brix; (II) initial clarification and decoloration (CD) of the syrup, with removal of insoluble materials and turbidity, through: (a) flotation of the syrup, (b) filtration of the flotated syrup, (c) demineralization of the filtrated syrup, (d) decoloration of the syrup in a second ionic change column (C2), containing an anionic resin bed, and (e) polish of the syrup in a third ionic change column (C3) containing an anionic resin bed; (III) cooking and crystallization (CC) of the syrup in sugar crystals and their centrifugation for separation of the remaining runoff syrup; and (IV) drying and storage (DS) of the granulated refined sugar.

### CROSS REFERENCE TO RELATED APPLICATIONS

This application is a continuation-in-part of U.S. application Ser. No. 11/719,758 filed May 21, 2007, which is a national phase application of international application PCT/BR05/00239 filed Nov. 22, 2005, both of which claim priority to Brazilian application PI0405323-0 filed Nov. 24, 2004. Applicant claims the priority dates of the above-mentioned applications for the present application and incorporates by reference the content of the priority documents.

### FIELD OF THE INVENTION

The present invention is related to a process for producing granulated refined sugar, of high purity and quality in terms of color and turbidity, to be used in food industry in general, directly from the sugar cane juice, in nature, that is, as it was extracted from the sugar cane, said juice generally presenting a concentration between 13° and 18° Brix.

### BACKGROUND OF THE INVENTION

The state of the art comprises a productive process in which the raw material used for obtaining saccharosis crystals of high purity and quality (granulated refined sugar) is the sugar cane syrup.

In the conventional sugar production process from sugar cane, there can be produced several types of crystal sugar, as illustrated hereinafter in table 1. The main difference between the types of sugar occurs as a function of its coloration, purity, ash content, turbidity, insoluble materials, impurities, metal content, starch and dextran contents. Typically, the impure raw sugars (not refined), as VHP and VVHP, are intended for exportation, to supply the sugar refineries which produce the granulated refined sugar. The white crystal sugar is widely used for domestic and industrial consumption.

As illustrated in FIG. 1 of the enclosed drawings, said conventional process comprises, basically, the steps of reception of the sugar cane, cleaning, cane preparation, juice extraction, chemical treatment of the juice, including the operations of heating the juice so that it can be submitted to subsequent steps of sulphitation with sulphur dioxide, liming with calcium hydroxide, flocculation through polyelectrolytes, clarification by means of decanters, for separation of the impurities, and filtration of the treated juice.

The clarified juice is then subjected to a concentration step, so that its original concentration, of 13-18° Brix, is elevated to a syrup concentration between 60° and 65° Brix, in evaporation devices, usually multiple effect evaporators, which use thermal energy from different sources available in the industrial plant, for example, steam, and also differences of pressure and temperature between their multiple bodies to efficiently concentrate the juice into a syrup.

The concentrated syrup is then submitted to steps of flocculation with flocculant agents, and flotation with injection of air or carbon dioxide, to produce a clarified syrup and a flotated foam, containing impurities. The flotation allows removing about 40-60% of the syrup turbidity, as well as about 20-30% of its initial color.

The flotated concentrated syrup is then submitted to a sugar cooking step, in which the saccharosis crystallization is made in devices named vacuum cookers, in which the syrup becomes even more concentrated, reaching a saturation level sufficient to provoke its desired crystallization.

In the crystallization step, the clarified sugar syrup is concentrated until reaching its supersaturation point between 1.15 and 1.2, when a certain amount of powdered sugar is added to serve as crystallization germ (“seed”) for production of saccharosis crystals in the cooking.

The cooking is extended until the point in which the crystals reach the adequate size and the vacuum cooker is filled up with its useful volume. The sugar mass is then discharged in tanks provided with agitation known as crystallizers and, subsequently, conducted to sugar centrifuges, which have the function of promoting the separation between the runoff syrup, which returns to the beginning of the process or to subsequent cookings, until its exhaustion point, and the saccharosis crystals, which are sent to drying and cooling. The runoff syrup is returned to the process, so that the residual sugar contained therein is crystallized and, thus, re-used.

In the interior of dryers-coolers, the saccharosis crystals are brought into contact with dry hot air, reducing their relative humidity from about 1.0-1.5% to a value between 0.04% and 0.10% (depending on the type of sugar being processed), being posteriorly cooled to temperatures of about 37-40° C. After the cooling step, the obtained crystal sugar is bagged, or otherwise stored or stocked.

The thus obtained sugar is called white crystal sugar and it is used as raw material in the conventional processes for obtaining granulated refined sugar.

For obtaining the granulated refined sugar, it is generally used, as raw material, a crystal sugar, such as VHP and VVHP, an impure raw sugar presenting high degree of color and impurities (see table 1 below).

In the production of the granulated refined sugar, from the raw crystal sugar, several unitary operations are required, as illustrated in FIG. 1.

The processing steps comprise: the dissolution of the crystal sugar in a raw juice with about 65° Brix, chemical-treatment of the raw juice with phosphoric acid and lime milk; addition of flocculant agents (anionic and cationic); flotation with air injection; filtration of the juice in pre-coat filters through a bed defined by an auxiliary filtration means (diatomaceous earth) and activated coal; feeding the juice into ionic change columns (cationic and anionic); concentration of the juice in vacuum evaporators; crystallization of the sugar in evapo-crystallizers; centrifugation of the crystallized mass; drying of the crystals; and sending the remaining runoff syrup to the process for sugar recovery. The use of these unitary operations ensures the reduction of the initial color of the impure raw sugar, for example, VVHP (400 ICUMSA) or VHP (1000 ICUMSA), to 40-50 ICUMSA in the final granulated refined sugar.

Among all the involved purification steps, the most important, with respect to removal of color and of impurities, is the crystallization, since this process is responsible for a color reduction of the order of 10-15 times in relation to the color of the initial juice fed into the crystallizers (see, for example, Rein, P. “Cane Sugar Engineering”, Bartens, ISBN 978-3-87040-110-8 and Chou, C. C. “Handbook of Sugar Refining”, John Wiley & Sons, ISBN 0-471-18357-1,2000).

As previously described, for obtaining the refined sugar, there are required practically two factories, a first factory, in which the raw crystal sugar is produced, and a second factory, in which the raw crystal sugar is dissolved and reprocessed in a plurality of unitary operations, until reaching the refined sugar.

It should be pointed out that the groups of operations carried out in two different facilities result, mainly, from the high loads of non-sugars contained in the concentrated syrup, mainly colored compounds, metals, ashes, polysaccharide, dextran, starch, amino acids, proteins among others. It should be noted that the raw syrup can present a color which varies between 7,000 and 18,000 UI (ICUMSA units), usually from 10,000 to 12,000, and the sugar to be obtained in the process must have a color of 500 UI, in the case of VVHP sugar, and of 1000 UI, in the case of VHP sugar. Therefore, the process for manufacturing the raw crystal sugar should promote a color removal in the syrup of the order of 10-15 times, which is, historically, the limit capacity of the process to reach the desired color for the sugar.

At the refinery, starting from, for example, a VVHP sugar with color of 1000 UI, to reach the refined sugar with color below 50 UI, the required color reduction is of 20 times, thus exceeding the upper limit of color removal in a refining process. Therefore, in the known process for producing the raw crystal sugar from sugar cane syrup, it is virtually unfeasible to obtain granulated refined sugar.

Evidently, as a function of the great number of unitary operations required for obtaining the granulated refined sugar, in two different industrial plants, there is a need for a huge investment in implementation, besides having to cope with a high operational cost, mainly due to the use of inputs and utilities.

In short, said known process requires double investment with similar equipment, high energy consumption, mainly due to re-dissolution and double cooking, as well as costly manpower (compare the processes illustrated in FIGS. 1 and 2).

### SUMMARY OF THE INVENTION

As a function of the prior art limitations, the present invention has the object of providing a process for obtaining granulated refined sugar, whose implementation is relatively simple and presents a high rate of return on investment, for the production of high purity granulated refined sugar directly from the sugar cane juice.

The high return on investment cited above is mainly associated with the difference of price between the sugar cane juice (lower price) and the white crystal or refined sugar, and the low OPEX value (cost of inputs and product processing).

The present process for producing granulated refined sugar further provides a new solution for the production of granulated refined sugar, directly from the syrup of the sugar cane juice, reducing its production cost, as well as the investments involved in the construction of the industrial plant.

### BRIEF DESCRIPTION OF THE DRAWINGS

The invention will be described below, with reference to the enclosed drawings in which:

FIG. 1 illustrates a flowchart representing the steps of a conventional process for obtaining granulated refined sugar, from sugar cane juice, using a first phase for crystallization of the concentrated syrup and, posteriorly, a second phase in which it is made a recrystallization of the crystal sugar obtained in the first phase;

FIG. 2 illustrates a flowchart representing the steps of the process according to the present invention;

FIG. 3 is a graph illustrating the efficiency in removing color from the syrup, by applying the decoloration steps illustrated in the flowchart of FIG. 2;

FIG. 4 is a graph illustrating the percentage values of color removal achieved in relation to the color of the concentrated syrup, which was submitted to the decoloration steps illustrated in the flowchart of FIG. 2;

FIG. 5 is a graph illustrating the correlations between the color of the concentrated syrup and the color of the sugar obtained by the process of the present invention; and

FIG. 6 is a graph illustrating the consumption of utilities, manpower and investment in faciliies which use conventional processes and the process of the present invention.

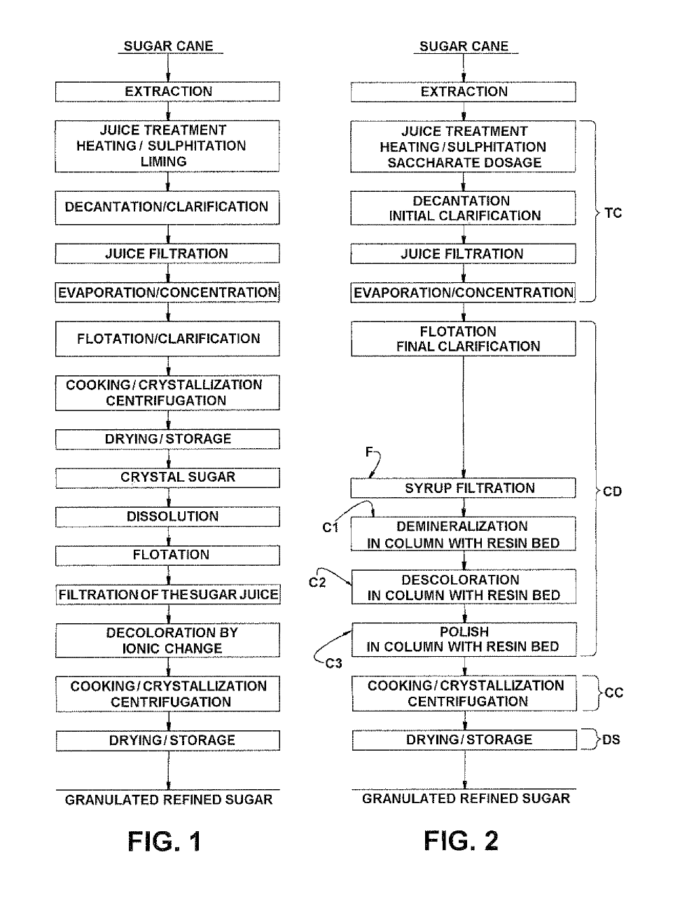

### DETAILED DESCRIPTION OF THE INVENTION

As illustrated in FIG. 2, the process of the present invention comprises, basically, a phase of treatment, initial clarification and concentration TC of the sugar cane juice into a clarified syrup, a phase of clarification and decoloration CD of the initially clarified syrup, a phase of cooking and crystallization CC, and a phase of drying and storage DS of the granulated sugar.

The phase of treatment, initial clarification and concentration TC comprises the known initial steps of chopping, defibering the sugar cane and extracting, therefrom, the juice rich in sugars.

The sugar cane juice is then submitted to steps of treatment by sulphitation with sulphur, dosage with calcium saccharate, heating until a temperature between 105° C. and 108° C., removal of gases dissolved in the juice through a balloon for the expansion and dosage of a flocculant agent, said juice being then subjected to a first step of initial clarification by means of decanters, so as to separate the impurities, followed by a step of filtration of the treated and clarified juice (initial purification).

The juice submitted to the initial clarification is then conducted to evaporation devices, usually multiple effect evaporators, to be submitted to an evaporation step, in which the original concentration of the clarified juice, in the range of about 13-18° Brix, is altered to a sugar syrup concentration in the range of about 60-65° Brix.

The concentrated sugar syrup is then submitted to a second (or final) clarification step, by means of a flocculation using phosphoric acid, commercial cationic decolorant, calcium saccharate and a polyacrylamide-based flocculant agent.

The flocculation should be made with injection of air or carbon dioxide, to produce a clarified syrup and a flotated foam, containing impurities and to be removed from the clarified syrup, for example by means of filtration, generally through beds containing filtration auxiliaries such as, for example, diatomaceous earth and activated coal. The flotation allows removing about 40-70% of the syrup turbidity, as well as about 20-50% of its initial color.

According to the present invention and as illustrated in FIG. 2, the process for producing granulated refined sugar from sugar cane juice, comprises the phases of:

I—treatment, initial clarification and concentration TC of the sugar cane juice, presenting a concentration of 13-18° Brix, through the steps of: treatment of the juice by sulphitation with sulphur (or phosphatation), dosage with calcium saccharate (or lime), heating to temperatures of 105-108° C., initial clarification by decantation, followed by filtration of the juice and concentration by evaporation, for reaching a syrup concentration of 60-65° Brix;

II—final clarification and decoloration of the syrup obtained in first phase I, with removal of insoluble materials in suspension and of turbidity, through the steps of:
submitting the syrup to a flotation using phosphoric acid, cationic decolorant, calcium saccharate and an anionic flocculant agent, and separating the clarified (or flotated) syrup;
passing the flocculated syrup in a belt filter or pressure differential filter F;
demineralizing the clarified (flotated) and filtrated syrup in a first ionic change column C1, containing a bed of cationic change synthetic resin, preferably the resin Amberlite DRD1000 produced by Rohm and Haas.
decolorating the demineralized syrup in a second ionic change column C2, containing a bed formed by an anionic resin with high color retaining capacity, preferably the ionic change resin AmberliteDRD3000; and
submitting the decolorated syrup to a polish or complementary deceleration in a third ionic change column C3, also containing a bed formed by an anionic resin with high color retaining capacity, preferably the ionic change resin Amberlite BRD5000;

III—cooking and crystallization CC of the syrup, with the cooking of the latter being extended until the point in which the sugar crystals reach a saturation level sufficient for the formation of sugar crystals which are submitted to centrifugation for separating said sugar crystals from the remaining runoff syrup, and for obtaining the granulated refined sugar; and

IV—drying and storage DS of the granulated refined sugar, with reduction of its relative humidity from 1.0-1.5% to about 0.04-0.08%, and of its temperature to the range of 37-40° C., for subsequent storage.

In the tests carried out, a clarified syrup, presenting a concentration of about 60-65° Brix, was passed, in the descending direction, through the pressure differential filter F, for removing the solids in suspension and the remaining turbidity from the flotated syrup. Subsequently, the clarified and filtrated syrup was passed, in an ascending direction, through the first, the second and the third ionic change columns C1, C2, C3, to be adequately purified and decolorated, for allowing its efficient crystallization to occur.

Decoloration tests were performed in three Brazilian conventional mills, located in the state of São Paulo, using the syrup resulting from the industrial process of said facilities. The tests were carried out in a pilot plant, with an average syrup flow rate of 350 L/h, with average decoloration operating cycles of 30 hours, and with the flow rate and temperature of the process being controlled in said ionic change columns. At the end of each cycle, the ionic change resins, used in the first, second and third columns C1, C2 e C3, were submitted to a regeneration process with alkaline brine solution (NaCl 10% and NaOH 0.02) and returned to the process in a new decoloration cycle. The ionic change resins were submitted to several operating cycles, and it was verified that the efficiency thereof was maintained.

Table 1 below presents the global results of the decoloration tests, emphasizing, for each operating cycle, the volume of the decolorated syrup, the input color and the output color of the syrup and the global efficiency of color removal. 48 decoloration cycles were carried out, in a total volume of 376,310 liters of syrup.

TABLE 1

| | | |
|---|---|---|
| Volume of | | |
| Decolorated | | Removal of |
| Syrup | ICUMSA Color | Color (%) |

| Cycle | (L) | INPUT | OUTPUT | Total |
|---|---|---|---|---|
| 1 | 3.654 | 8.315 | 3.800 | 55 |
| 2 | 5.460 | 6.852 | 3.693 | 44 |
| 3 | 5.472 | 8.776 | 4.024 | 45 |
| 4 | 5.480 | 8.042 | 3.729 | 51 |
| 5 | 5.470 | 8.387 | 3.596 | 56 |
| 6 | 10.032 | 9.753 | 6.096 | 30 |
| 7 | 5.016 | 9.780 | 4.040 | 56 |
| 8 | 4.560 | 7.527 | 3.600 | 55 |
| 9 | 4.104 | 7.784 | 3.296 | 56 |
| 10 | 3.192 | 6.800 | 2.100 | 70 |
| 11 | 7.292 | 7.420 | 4.160 | 42 |
| 12 | 5.016 | 7.600 | 2.740 | 64 |
| 13 | 5.481 | 7.958 | 3.476 | 55 |
| 14 | 5.474 | 7.720 | 3.593 | 54 |
| 15 | 5.928 | 7.515 | 3.555 | 53 |
| 16 | 5.918 | 8.420 | 4.220 | 51 |
| 17 | 5.016 | 9.667 | 3.744 | 62 |
| 18 | 6.842 | 9.820 | 5.633 | 62 |
| 19 | 3.192 | 8.180 | 3.622 | 56 |
| 20 | 3.650 | 8.360 | 4.231 | 51 |
| 21 | 13.750 | 8.982 | 3.643 | 61 |
| 22 | 9.760 | 10.055 | 4.541 | 53 |
| 23 | 6.870 | 8.662 | 4.053 | 53 |
| 24 | 9.200 | 7.992 | 4.758 | 39 |
| 25 | 7.575 | 11.037 | 5.297 | 51 |
| 26 | 9.530 | 11.217 | 7.524 | 33 |
| 27 | 9.083 | 12.295 | 6.754 | 46 |
| 28 | 6.006 | 7.227 | 4.273 | 41 |
| 29 | 4.364 | 7.910 | 4.190 | 45 |
| 30 | 4.560 | 7.771 | 2.806 | 61 |
| 31 | 6.840 | 7.232 | 3.888 | 48 |
| 32 | 8.358 | 7.778 | 3.130 | 61 |
| 33 | 16.416 | 9.026 | 3.820 | 58 |
| 34 | 10.944 | 9.583 | 5.457 | 42 |
| 35 | 9.550 | 8.913 | 3.825 | 68 |
| 36 | 10.488 | 8.570 | 4.863 | 44 |
| 37 | 9.576 | 8.294 | 4.550 | 45 |
| 38 | 6.384 | 8.150 | 3.620 | 56 |
| 39 | 12.312 | 8.074 | 3.545 | 57 |
| 40 | 14.136 | 7.885 | 3.633 | 52 |
| 41 | 13.680 | 8.133 | 4.424 | 42 |
| 42 | 20.064 | 9.864 | 5.557 | 47 |
| 43 | 8.208 | 8.913 | 3.350 | 63 |
| 44 | 8.664 | 12.863 | 5.885 | 39 |
| 45 | 9.120 | 9.690 | 4.833 | 48 |
| 46 | 9.120 | 10.867 | 5.109 | 50 |
| 47 | 9.120 | 9.122 | 3.914 | 58 |
| 48 | 6.384 | 10.447 | 4.263 | 60 |
| Media | | 8.776 | 4.216 | 52 |

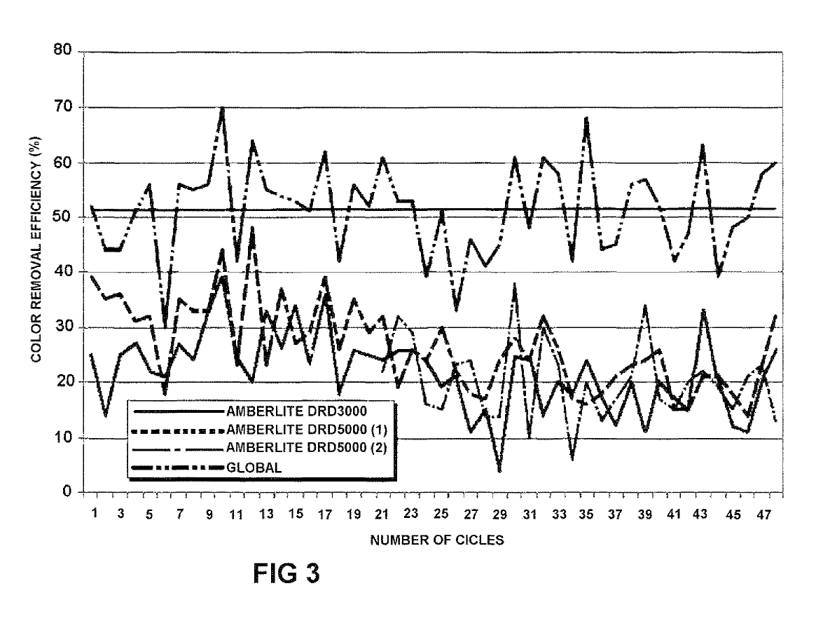

As can be noted, the color of the input syrup varied between 6800 and 12863 ICUMSA, presenting an average value of 8776. The color of the decolorated syrup presented values between 2100 and 7524, with an average result of 4216. FIG. 3 illustrates the efficiency in removing color from the syrup.

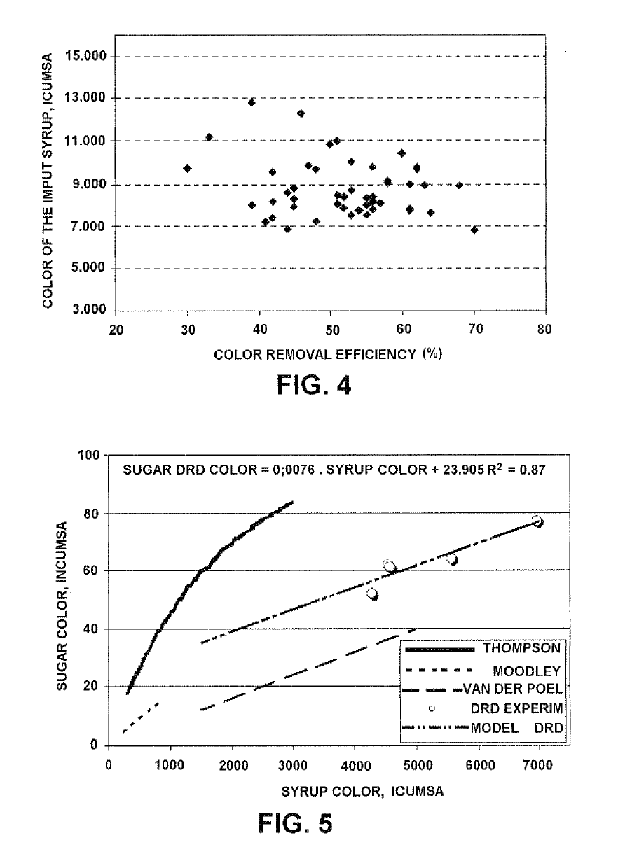

The ionic change resins fulfilled the initial expectations of color removal efficiency, with an average value of 52%, further maintaining the decoloration capacity, as illustrated in FIG. 4 of the enclosed drawings.

At the end of the 48 experimental decoloration cycles, there were collected samples of the ionic change resins, which were submitted to analyses by Rohm and Haas in the United States.

FIG. 5 of the enclosed drawings presents the percentage values of color removal as a function of the syrup input color. It was verified that the lower the coloration presented by the input syrup, the more efficient is the color removal, reaching a value of 70% when the input syrup presents a color of 6800 ICUMSA. It is further possible to verify a greater concentration of the results around the value of 50% of color removal, with a standard deviation of only 8.6%, thus emphasizing the performance of the resins for this efficiency value.

After finishing the phase of decoloration CD of the concentrated and already initially clarified syrup, the syrup is stored in tanks, until obtaining a volume adequate to the continuity of the process, being then submitted to the phase of cooking and crystallization CC.

In the phase of cooking and crystallization CC, the filtrated and decolorated syrup is submitted to a sugar cooking step, in which the saccharosis crystallization is made in devices named vacuum cookers, in which the syrup becomes even more concentrated, reaching a saturation level sufficient to provoke the desired crystallization.

In the crystallization step, the clarified sugar syrup is concentrated until reaching its supersaturation point, when a certain amount of powdered sugar is added to serve as a crystallization germ (seed) for producing saccharosis crystals in the cooking.

The cooking is extended until the point in which the crystals reach the desired size and the vacuum cooker is completely full. The sugar mass is then discharged in tanks known as crystallizers and, subsequently, conducted to sugar centrifuges, which provide the separation between the runoff syrup, which returns to the beginning of the process or to subsequent cookings, until its exhaustion point. The saccharosis crystals are sent to the drying and storage phase DS. The runoff syrup is returned to the process, for allowing the residual sugar contained therein to be crystallized and, thus, re-used.

According to the tests performed in the pilot plant, the phase of cooking and crystallization CC was carried out in a vacuum cooker, with capacity of 200 hl (20 m³).

Table 2 below presents the crystallization results, with the respective colors of the syrup and of the obtained sugar. The crystallizations from 1 to 6 were carried out with the decolorated syrup of mill 1, and the crystallizations from 7 to 11 with the syrup of mill 2.

TABLE 2

| | | Average | Average |
|---|---|---|---|
| | | ICUMSA Color | ICUMSA Color |
| Mill | Crystallization | of the Syrup | of the Sugar |
| 1 | 1 | 3.643 | 37 |
| | 2 | 4.291 | 52 |
| | 3 | 4.557 | 62 |
| | 4 | 5.710 | 32 |
| | 5 | 5.237 | 44 |
| | 6 | 5.389 | 42 |
| | Average 1 | 4.804 | 44 |
| 2 | 7 | 5.572 | 64 |
| | 8 | 7.776 | 59 |
| | 9 | 6.969 | 77 |
| | 10 | 5.274 | 88 |
| | 11 | 4.578 | 61 |
| | Average 2 | 6.034 | 70 |

It can be noted that, in the crystallizations from 1 to 6, it was obtained a sugar of color 44 ICUMSA, directly complying with the specifications of the granulated refined sugar. In the crystallizations from 7 to 11, it was obtained a sugar whose average color was slightly higher as a function of the lower quality of the raw material used. However, in both cases and as presented above, the decoloration efficiency, obtained by means of the ionic change resins, was maintained above 50%.

The cooking step, such as described above, was carried out in a conventional manner, but it should be understood that employing more sophisticated cooking alternatives such as, for example, dissolution of the magma in the syrup for increasing its purity, can produce sugar crystals with even lower color degrees.

As already mentioned above, the sugar crystals, obtained in the phase of cooking and decoloration CD, are submitted to the phase of drying and storage DS in the interior of a drying-cooling equipment, in which the sugar crystals are brought into contact with dry hot air, reducing their relative humidity from about 1.0-1.5% to about 0.04-0.080, being posteriorly cooled to temperatures of about 37-40° C. After the cooling, the obtained granulated refined sugar is bagged, or otherwise stored or stocked.

Using crystallization data with color reduction lower than 100, a relation was made between the color of the input syrup in the cooking equipment and the color of the obtained granulated refined sugar, resulting in the following correlation:

Color of the obtained sugar=0.0076×color of the syrup 1-23.905

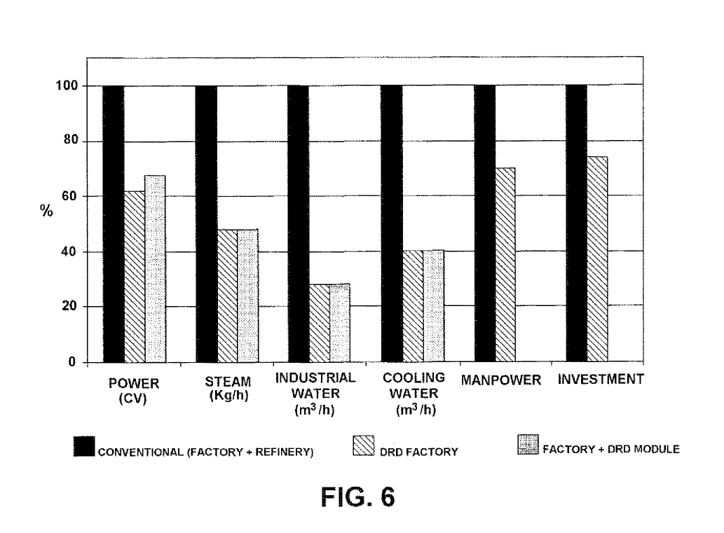

Several authors present similar correlations for the refined sugar color as a function of the syrup color, as it occurs with the correlation of Thompson et al. (2006), which results from crystallization data of four refineries which use four cooking steps. Other correlations are from Moodley et al (2000), applied to refinery juice, and from Van Der Poel et al., (1986), which correlations, together with that obtained by the process of the present invention (DRD), are presented in FIG. 6.

It can be noted that the correlation obtained by the crystallization in the present process (DRD—Dedini Directly Refined) is in accordance with the correlations of several authors, and it is important to emphasize that each Mill presents different conditions regarding raw material and process, making it difficult to provide a unique model for said process.

With the purpose of demonstrating the economic advantages obtained by the process for producing granulated refined sugar in a single industrial plant, there were raised values related to consumption of utilities, manpower and investment in the process of the present invention (DRD process), which values can be compared to the corresponding values obtained in a conventional plat for the production of refined sugar.

Graph of FIG. 6 further illustrates the same values when a phase of filtration and decoloration of the syrup is introduced in an existing sugar factory (Factory+Phase D of the DRD process).

It can be noted, through the graph of FIG. 6, that the production of granulated refined sugar, by the process of the present invention (DRD process), requires about 300 less electric energy consumption. Regarding the utilities, the reduction is even more significant, being 50% for the steam and about 60% for the industrial and cooling waters. Due to the lower need for equipment and process steps, the amount of investment and manpower will be consequently reduced.

Some of the improvements introduced in the present process (DRD) were carried out directly in the field, with industrial scale equipment, and proved to be very efficient.

The phase of filtration and deceleration of the syrup by ionic change, using resins specially developed to operate with the raw material defined by sugar cane juice, proved to be very efficient, remaining above 50% for the most adverse syrup conditions found in the Sugar Mills.

The use of the present process for production of granulated refined sugar, in a direct manner, that is, without recrystallization, presents a series of advantages in relation to the conventional production processes. Among said advantages, there can be pointed out:

less consumption of energy, steam, water and manpower, due to the elimination of several steps of the conventional processes with recrystallization;

reduction of the production costs;

operational flexibility, since is possible to produce, in a single plant, several types of sugar, such as white crystal sugar, the VVHP, the VHF and the granulated refined sugar, and, thus, meet the momentary needs of the market;

more compact facilities and in a single plant, eliminating the investment in buildings and additional facilities which are required by the conventional processes;

eliminating the need of handling the already stored crystal sugar/VHP, avoiding losses upon handling the raw material, as it occurs in the conventional processes;

implementing an entirely new plant or adapting an already existing plant;

using the plant with the purpose of maintaining the quality of the product during the crop, eliminating the influence of extended periods of rain, variations in quality of raw material, etc. This is possible by action of the resins which can actuate as color reducing means in the juice effluent from the decoloration process. A color sensor actuates in the incoming syrup flowrate as a function of the output color.

What is claimed is:

1. A process for producing granulated refined sugar from sugar cane juice, characterized in that it comprises the phases of:
I) treatment, initial clarification and concentration (TC) of the sugar cane juice, presenting a concentration of 13-18° Brix, through the steps of: treatment of the juice by sulphitation with sulphur (or phosphatation), dosage with calcium saccharate (or lime milk), heating to temperatures of 105-108° C., initial clarification by decantation, filtration of the juice and concentration by evaporation, for a syrup concentration of 60-65° Brix;
II) final clarification and decoloration of the syrup obtained in first phase I, with removal of insoluble materials in suspension and of turbidity, through the steps of:
a) submitting the syrup to a flotation using phosphoric acid, cationic decolorant, calcium saccharate and an anionic flocculant agent, and separating the clarified (flotated) syrup;
b) filtrating the clarified (flotated) syrup;
c) demineralizing the clarified (flotated) and filtrated syrup in a first ionic change column (C1), containing a bed of cationic change resin;
d) decolorating the demineralized syrup in a second ionic change column (C2), containing a bed formed by an anionic resin with high color retaining capacity; and
e) submitting the decolorated syrup to a polish or complementary decoloration in a third ionic change column (C3), also containing a bed formed by a resin with high color retaining capacity;
III) cooking and crystallization (CC) of the syrup, the cooking of the latter being extended until the point of formation of the sugar crystals, which are submitted to centrifugation, to be separated from the remaining runoff syrup for obtaining the granulated refined sugar; and
IV) drying and storage (DS) of the granulated refined sugar.

2. The process, as set forth in claim 1, characterized in that the cationic change resin, forming the bed of the first ionic change column (C1), is the resin Amberlite DRD1000, the anionic resin of high color retaining capacity, used in the second ionic change column (C2) being defined by the ionic change resin Amberlite DRD3000 and, the ionic resin used in the third ionic change column (C3) being defined by the resin Amberlite DRD5000.

3. The process, as set forth in claim 1, characterized in that the clarified syrup, presenting a concentration of about 60-65° Brix, passes, in the descending direction, through the centrifuge or pressure differential filter (F), for removal of solids in suspension and turbidity from the syrup, in the ascending direction, through the first, second and third ionic change columns (C1, C2, C3).

4. The process, as set forth in claim 2, characterized in that the clarified syrup, presenting a concentration of about 60-65° Brix, passes, in the descending direction, through the centrifuge or pressure differential filter (F), for removal of solids in suspension and turbidity from the syrup, in the ascending direction, through the first, second and third ionic change columns (C1, C2, C3).

5. The process, as set forth in claim 1, characterized in that the step of filtration of the flotated syrup, in the phase of final clarification and decoloration (CD), is carried out in a belt or pressure differential filter (F).

6. The process, as set forth in claim 2, characterized in that the step of filtration of the flotated syrup, in the phase of final clarification and decoloration (CD), is carried out in a belt or pressure differential filter (F).

7. The process, as set forth in claim 3, characterized in that the step of filtration of the flotated syrup, in the phase of final clarification and decoloration (CD), is carried out in a belt or pressure differential filter (F).

8. The process, as set forth in claim 4, characterized in that the step of filtration of the flotated syrup, in the phase of final clarification and decoloration (CD), is carried out in a belt or pressure differential filter (F).

9. The process, as set forth in claim 1, characterized in that the drying of the granulated refined sugar reduces its relative humidity from the range of 1.0-1.5% to the range of 0.04-0.08%, and its temperature to the range of 37-40° C.

10. The process, as set forth in claim 2, characterized in that the drying of the granulated refined sugar reduces its relative humidity from the range of 1.0-1.5% to the range of 0.04-0.08%, and its temperature to the range of 37-40° C.

11. The process, as set forth in claim 3, characterized in that the drying of the granulated refined sugar reduces its relative humidity from the range of 1.0-1.5% to the range of 0.04-0.08%, and its temperature to the range of 37-40° C.

12. The process, as set forth in claim 4, characterized in that the drying of the granulated refined sugar reduces its relative humidity from the range of 1.0-1.5% to the range of 0.04-0.08%, and its temperature to the range of 37-40° C.

13. The process, as set forth in claim 5, characterized in that the drying of the granulated refined sugar reduces its relative humidity from the range of 1.0-1.5% to the range of 0.04-0.08%, and its temperature to the range of 37-40° C.

14. The process, as set forth in claim 6, characterized in that the drying of the granulated refined sugar reduces its relative humidity from the range of 1.0-1.5% to the range of 0.04-0.08%, and its temperature to the range of 37-40° C.

15. The process, as set forth in claim 7, characterized in that the drying of the granulated refined sugar reduces its relative humidity from the range of 1.0-1.5% to the range of 0.04-0.08%, and its temperature to the range of 37-40° C.

16. The process, as set forth in claim 8, characterized in that the drying of the granulated refined sugar reduces its relative humidity from the range of 1.0-1.5% to the range of 0.04-0.08%, and its temperature to the range of 37-40° C.
